(19) United States
(12) Patent Application Publication
(10) Pub. No.: US 2015/0111130 A1
(43) Pub. Date: Apr. 23, 2015

(54) METHOD FOR FORMULATING A CERAMIC POWDER FOR PRODUCING A PROTON-CONDUCTING ELECTROLYTIC MEMBRANE FOR AN ELECTROCHEMICAL CELL

(71) Applicant: AREVA, Courbevoie (FR)

(72) Inventors: Béatrice Sala, Saint Gely Du Fesc (FR); Frédéric Grasset, Montpellier (FR); Dominique Goeuriot, Monistrol sur Loire (FR); Baroudi Bendjeriou, Saint-Etienne (FR)

(21) Appl. No.: 14/368,842

(22) PCT Filed: Dec. 26, 2012
(86) PCT No.: PCT/EP2012/076909

§ 371 Date: Jun. 26, 2014

(30) Foreign Application Priority Data
Dec. 27, 2011 (FR) 1162482

(51) Int. Cl. C25B 11/04; H01M 8/10

(52) U.S. Cl. CPC C25B 11/04; H01M 8/1016; H01M 2300/0074; H01M 2008/1293
USPC 429/488; 204/291; 252/62.2

(57) ABSTRACT

A method for formulating a ceramic power for producing a proton-conducting electrolytic membrane for an electrochemical cell, includes forming a suspension of a previously synthesized, unprocessed ceramic powder in a solvent having a hydrogen potential greater than 7 so as to produce a slip, the unprocessed ceramic powder including agglomerates consisting of a plurality of ceramic grains, crushing the agglomerates contained in the slip so as to reduce the agglomerates, and drying the slip so as to mechanically separate the agglomerates from the solvent and recover the dried agglomerates.

### TECHNICAL FIELD

The field of the invention is electrochemical devices such as SOFC or PCFC fuel cells and SOEC type high temperature electrolysers comprising a proton-conducting membrane made from a ceramic powder.

The invention more particularly relates to a method for formulating a ceramic power used to make a proton-conducting electrolytic membrane for an electrolyser electrochemical cell.

The invention also relates to fuel cells, to which technological developments of high temperature electrolysers are directly applicable.

### STATE OF THE ART

Technologies currently used for high temperature electrolysers, for example SOEC (Solid Oxide Electrolyser Cell) or fuel cells for example of the SOFC (Solid Oxide Fuel Cell) type are based on the use of two electrically conducting electrodes, separated by an electrolyte with an electrically insulating and ion-conducting (preferably proton-conducting) membrane forming a structure called an electrochemical cell or an elementary assembly.

The ion-conducting electrolytic membrane of high temperature electrolysers is conventionally formed from a ceramic powder. The ceramic power may for example be a stabilised zirconia powder for making an anion-conducting ceramic or a doped perovskite structure powder (zirconate, titanate, cerate, etc.) for making a proton-conducting ceramic.

The electrolytic membrane has to be as thin as possible so as to minimise the pure resistance inside an electrochemical cell.

Furthermore, the electrolytic membrane must also be uniform and sufficiently dense so that it is leak tight to gas between the anode and the cathode of the electrolytic cell.

### PRESENTATION OF THE INVENTION

In this context, the invention is aimed at disclosing a method for formulating a ceramic powder for making a proton-conducting electrolytic membrane of an electrochemical cell so as to make thin electrolytic membranes while improving their uniformity and their densification rate for a given composition, temperature and sintering atmosphere.

To achieve this, the invention discloses a method of formulating a ceramic powder for making a proton-conducting electrolytic membrane of an electrochemical cell, said method including the following steps:
create a suspension of a previously synthesised unprocessed ceramic powder in a solvent with a hydrogen potential of more than 7, so as to make a slip, said unprocessed ceramic powder comprising agglomerates formed by a plurality of ceramic grains;
crush said agglomerates contained in said slip so as to reduce said agglomerates;
dry said slip so as to mechanically separate said agglomerates from said solvent and to recover said dried agglomerates.

Drying is preferably done using the atomisation technique, which corresponds to the division of a liquid compound (attritiated slip) into fine droplets in the form of a spray so as to facilitate drying of said liquid, each sprayed droplet behaving like a reactor and individually drying the others to form small aggregates of particles not agglomerated to each other.

The formulation method according to the invention can give a formulated polycrystalline ceramic powder with fewer agglomerates than conventional off-the-shelf polycrystalline ceramic powders. It will be remembered that agglomerates are formed by clusters of ceramic powders, these grains preferably being nanometric in size, with a diameter possibly less than 100 nanometers.

Advantageously, the formulation method according to the invention can give a ceramic powder with agglomerates of particles possibly with multimodal sizes smaller than 10 microns (compared with several tens of microns or even 100 microns for a conventional so-called unprocessed ceramic powder).

The size of the agglomerates is advantageously reduced by atomisation of the slip and by the step to dry each droplet individually, in other words separately from another droplet. Individual drying thus individually dries the small agglomerates contained in the droplets, preventing a new agglomeration of the particles.

Thus, the drying method can eliminate the reformation of larger agglomerates if the ceramic powder is dried for example by evaporation of the solvent in air.

Advantageously, the drying means is a cyclone heated to mechanically separate the particles present in each drop vaporised by evaporation of the solvent.

The use of a solvent with a hydrogen potential of more than 7 favours the dispersion of the unprocessed ceramic powder with a basic hydrogen potential.

The formulation method for a ceramic powder for making an electrolytic membrane of an electrochemical cell according to the invention may also have one or several of the following characteristics, considered individually or in any technically possible combination:
said drying step is done by atomisation of said slip in a drying chamber;
said drying chamber is a heated gas cyclone capable of mechanically separating said agglomerates from said solvent;
said solvent is water;
said crushing step is done by attrition;
said agglomerate crushing step is done using zirconium balls;
said step to create a suspension is done in a mix formed by said solvent and a dispersant, for example polyacrylic acid, to favour dispersion of agglomerates of said ceramic powder.

Another purpose of the invention is a formulated ceramic powder obtained by the formulation method according to the invention, characterised in that said ceramic powder comprises agglomerates smaller than 10 microns.

Another purpose of the invention is an electrolytic membrane of an electrochemical cell fabricated using a ceramic powder formulated by the method according to the invention.

### BRIEF DESCRIPTION OF THE FIGURES

Other characteristics and advantages of the invention will become clearer after reading the following description given for guidance and in no way limitative, with reference to the appended figures among which:

FIG. 1 diagrammatically shows a section through an electrochemical cell comprising an electrolytic membrane made from a ceramic powder obtained using the formulation method according to the invention;

FIG. 2 shows a mimic diagram of the method of formulating a ceramic powder for making an electrolytic membrane of an electrochemical cell according to the invention.

### DETAILED PRESENTATION OF AT LEAST ONE EMBODIMENT

The formulation method according to the invention can be used to prepare a formulated ceramic powder from an unprocessed ceramic powder with the special feature that it has improved size grading, in other words the size of agglomerates formed by particle clusters is less than the size of agglomerates present in a conventional ceramic powder.

This powder thus obtained with the method according to the invention is thus conventionally used to make an electrolytic membrane of a photon-conducting electrochemical cell.

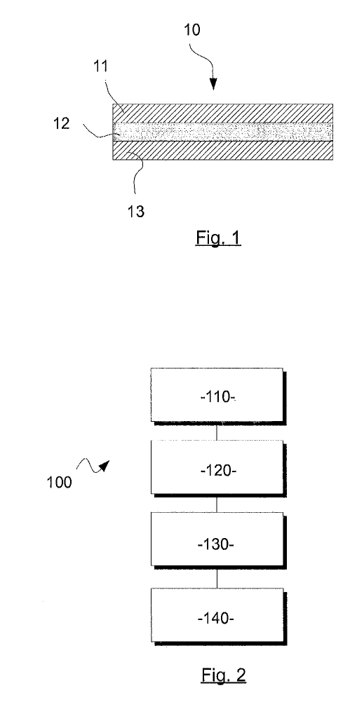

FIG. 1 shows a typical electrochemical cell 10 of an electrolyser formed by stacking an anode 11, a proton-conducting electrolytic membrane 12 made from a ceramic powder making use of the formulation method according to the invention, and a cathode 13.

FIG. 2 shows a mimic diagram of the main steps of the formation method 100 according to the invention.

The first step 110 is a step to synthesise the ceramic powder that will be used to make the electrolytic membrane 12. A mechanical crushing step may be applied, for example using a ball crusher, in order to put the unprocessed ceramic powder into suspension when the slip is made.

The second step 120 is a step to make a slip. The slip consists of putting the unprocessed ceramic powder into suspension in a solvent, advantageously water, with a hydrogen potential of more than 7. The use of the solvent with a hydrogen potential of more than 7 facilitates dispersion of the unprocessed ceramic powder that has a basic hydrogen potential.

A dispersant is added into the slip to make the slip stable. For example, the dispersant may be a polyacrylic acid.

According to another embodiment of the invention, water may be replaced by another type of solvent, for example such as an organic solvent such as an alcohol, for example ethanol

The third step 130 in the formulation method is a step for attrition of the slip prepared during the previous step.

This step 130 consists of mechanically crushing the agglomerates of ceramic particles using zirconia balls. Crushing is done by rotating the slip with zirconia balls at high speed, in order words of the order of 2000 rev per minute. It is estimated that a crushing time of between 0.5 and 2 hours at 2000 rev per minute is sufficient to obtain a uniform and desired size grading.

This attrition or crushing step will thus reduce the size of particle agglomerates through collisions between the zirconia balls and the agglomerates of ceramic particles or when an agglomerate is between 2 balls that either collide with each other or in a collision between a ball and the wall of the attrition unit.

The fourth step 140 is a slip-drying step by atomisation. This step 140 consists of atomising the slip in the form of a spray composed of a plurality of fine droplets in a drying chamber, for example a heated gas cyclone. The drying chamber will thus mechanically separate water and the ceramic particles contained in each of the fine droplets. Water forming the droplets will then evaporate in the chamber, consequently releasing the ceramic particles contained in it. The ceramic particles will then drop by gravity into the bottom of the cyclone. Thus, this step 140 can result in a dry powder with a size grading smaller than the size grading of the unprocessed ceramic powder.

The drying chamber inlet and outlet temperatures are more than 105° C. so as to prevent a condensation phenomenon of the solvent (i.e. water) in the drying chamber and in the dry ceramic particles collector. Advantageously, the inlet to the drying chamber is of the order of 300° C.

Advantageously, the formulation method thus disclosed can give a zirconate type ceramic with a size grading smaller than 10 microns.

This ceramic powder thus formulated is then used to make a proton-conducting electrolytic membrane, and also to make electrodes of an electrochemical cell 10.

Conventionally, an electrochemical cell 10 may be made by two methods: by pouring in strips or co-compaction of powders. The strip pouring method can control the thickness of the different layers and make very thin layers, for example with a thickness of less than 150 micrometers. This method is used mainly for making thin homogeneous layers.

With pouring in strips, each layer in the electrochemical cell 10 can be made independently.

The pouring in strips method consists of putting the ceramic powder formulated according to the invention into suspension so as to make a slip. The slip is made by creating a suspension of the ceramic powder in a mix composed of a solvent such as water, and a binder such as sodium alginate, the binder being used to increase the viscosity of the slip and to make the poured strip cohesive. It is also possible to add a dispersant to the suspension so as to stabilise the suspension. It is also possible to add a plastifier to the suspension to increase the plasticity of the poured strip.

When this strip pouring method is used to make a cermet electrode, metallic particles making up the cermet are also added into the suspension.

This slip is then laid on an appropriate support so as to make a liquid strip, particularly by using a knife or a pouring shoe mounted on a micrometric screw to control the thickness of the strip.

This slip strip is then immersed in a calcium chloride bath. The calcium chloride will gel the strip so that it can be manipulated. During this step, the suspension will transform into gel due to the formation of calcium alginate macromolecules through the formation of a three-dimensional lattice due to the substitution of monovalent sodium ions by divalent calcium ions, as counter-ions of alginate anion functions.

After the gel step, the strips have sufficient mechanical resistance so that they can be manipulated; they are then cut out with a part cutter to obtain disk-shaped layers. After drying, the disks are superposed in a matrix to create a conventional anode/electrolyte/cathode stack of an electrochemical cell 10.

The stack thus formed is then hot pressed to glue the disks to each other to make an assembly. This pressing or compaction step assures that the density of the electrolyte after sintering will be more than 90%. Finally, the compacted stack will be subjected to a sintering heat treatment.

According to a second embodiment, the electrochemical cell 10 is made directly by superposition of different ceramic powders formulated according to the invention in a cylindrical matrix, so as to obtain the anode/electrolyte/cathode stack.

The assembly is then compacted so as to obtain the assembly and then sintered to densify the electrolytic membrane as described above in the first embodiment of the electrochemical cell 10.

In this second embodiment of the electrochemical cell 10, the method of formulating the ceramic powder according to the invention may comprise an additional step consisting of adding a binder and a plastifier into the slip after attrition that will facilitate compaction of the ceramic particles during the compaction step.

The invention has been described particularly with reference to a zirconate type ceramic. However, the invention is also applicable to any type of ceramic provided that the size grading is not too large and/or too polydispersed.

Naturally, the invention is not limited to the embodiments described with reference to the figures and variants could be envisaged without going outside the framework of the invention. The proportions of the different materials are given only for illustration. The geometry of the electrochemical cell may also be different from the disclosed geometry.

1. A Method for formulating a ceramic power to make a proton-conducting electrolytic membrane of an electrochemical cell, said method comprising:
creating a suspension of a previously synthesised unprocessed ceramic powder in a solvent with a hydrogen potential of more than 7, so as to make a slip, said unprocessed ceramic powder comprising agglomerates formed by a plurality of ceramic grains;
crushing said agglomerates contained in said slip so as to reduce said agglomerates;
drying said slip so as to mechanically separate said agglomerates from said solvent and to recover said dried agglomerates.

2. The method for formulating a ceramic power to make an electrolytic membrane of an electrochemical cell according to claim 1, wherein said drying is done by atomisation of said slip in a drying chamber.

3. The method for formulating a ceramic power to make an electrolytic membrane of an electrochemical cell according to claim 2, wherein said drying chamber is a heated gas cyclone capable of mechanically separating said agglomerates from said solvent.

4. The method for formulating a ceramic power to make an electrolytic membrane of an electrochemical cell according to claim 1, wherein said solvent is water.

5. The method for formulating a ceramic power to make an electrolytic membrane of an electrochemical cell according to claim 1, wherein said crushing is done by attrition.

6. The method for formulating a ceramic power to make an electrolytic membrane of an electrochemical cell according to claim 1, wherein said agglomerate crushing is done using zirconia balls.

7. The method for formulating a ceramic power to make an electrolytic membrane of an electrochemical cell according to claim 1, wherein creating the suspension is done in a mix formed by said solvent and a dispersant to facilitate dispersion of agglomerates of said ceramic powder.

8. A formulated ceramic powder obtained by the formulation method according to claim 1, wherein said ceramic powder comprises agglomerates smaller than 10 micron meters (μm).

9. An electrolyte membrane of an electrochemical cell made using a ceramic powder according to claim 8.

10. The method for formulating a ceramic power to make an electrolytic membrane of an electrochemical cell according to claim 7, wherein the dispersant is polyacrylie acid.
